(19) United States
(12) Patent Application Publication
(10) Pub. No.: US 2020/0354189 A1
(43) Pub. Date: Nov. 12, 2020

(54) ELEVATOR COMMUNICATION SYSTEMS

(71) Applicant: Otis Elevator Company, Farmington, CT (US)

(72) Inventors: Jan Ruhnke, Berlin (DE); John F. Kleine, JR., Manchester, CT (US); Gloria Victoria Mariscal, Douglas, AZ (US); Hiromitsu Miyajima, Inzai (JP); Atsushi Yamada, Narita-shi (JP); Keiji Hashimoto, Sakura (JP); Hisanori Seki, Tomisato-Shi (JP)

(21) Appl. No.: 16/404,086

(22) Filed: May 6, 2019

(51) Int. Cl. B66B 1/34; B66B 1/14; B66B 1/46; B66B 3/00

(52) U.S. Cl. CPC B66B 1/3461; B66B 1/14; B66B 2201/4607; B66B 3/002; B66B 2201/10; B66B 1/468

(57) ABSTRACT

An elevator car 104 is provided which comprises an elevator control device 106 arranged to accept an elevator control command from a passenger in the elevator car 104. The elevator car is arranged to receive a query from a support provider 116; communicate said query to the passenger; and send a response to the support provider 116 based on passenger input provided via the elevator control device 106.

### TECHNICAL FIELD

The present disclosure relates to communication systems for elevators.

### BACKGROUND

Passengers travelling in an elevator car occasionally need to communicate with a dispatcher or support technician located outside of the elevator car (e.g. if the passenger is trapped in the elevator). This communication often comprises one or more queries issued by the dispatcher or support technician, for example, regarding the state of operation of the car or the wellbeing of the passenger(s), to which the passenger responds.

Conventionally, a voice-based communication system is used to facilitate this communication (i.e. comprising a microphone and a loudspeaker located in the car). A passenger listens to queries from the support technician and responds by speaking their response into the microphone. The queries and responses are typically sent to and from the elevator car over a telephone line.

However, such systems can be difficult or even impossible for some people to use (e.g. mute or deaf people) and can be rendered unusable if there is a high level of ambient noise or insufficient communication bandwidth. An alternative approach is desired.

### SUMMARY

According to a first aspect of the present disclosure there is provided an elevator car comprising an elevator control device arranged to accept an elevator control command from a passenger in the elevator car; wherein the elevator car is arranged to: receive a query from a support provider; communicate said query to the passenger; and send a response to the support provider based on passenger input provided via the elevator control device.

According to a second aspect of the present disclosure there is provided a method of communication between a passenger in an elevator car and a support provider, said car comprising an elevator control device arranged to accept an elevator control command from the passenger, said method comprising: the elevator car receiving a query from the support provider; communicating said query to the passenger; and sending a response to the support provider based on passenger input provided via the elevator control device.

Viewed from another aspect, the present disclosure provides a method of communicating with a passenger in an elevator car, said car comprising an elevator control device arranged to accept an elevator control command from the passenger, said method comprising: communicating a query to said passenger; and producing a response to said query based on an input to the elevator control input device.

Because the response to the query is based on passenger input to the elevator control device rather than, for example, a voice-based system, communication with the passenger is made more reliable and more accessible. For example, the passengers intended response may be reliably sent even when there is a high level of ambient noise in the elevator car, or when the passenger is physically unable to use a speech-based phone system.

Additionally, using passenger input to the elevator control device rather than a voice-based system reduces the bandwidth required of a communication link between the support provider and the elevator car, as the response does not comprise audio data but may instead comprise smaller text or numeric data packets (e.g. a single bit to represent a YES or NO response). The elevator car and the support provider may be connected via a telephone line. However, because the amount of data associated with the response may be reduced compared to voice-based systems, in some examples the elevator car and the support provider may be connected via a low bandwidth communication link (e.g. a link according to the NB-IoT or Cat-M1 protocols). The reduction in bandwidth required to transmit messages may also be beneficial by allowing more reliable, redundant and error-tolerant communication protocols. This may be particularly advantageous in emergency situations where there may be unusually high levels of interference or damage to the communication equipment. Thus the lower bandwidth messages and replies have a better chance of achieving successful communication.

The support provider may comprise a dedicated support centre (e.g. remote support centre located remotely from the building in which the elevator car operates or a local support centre located inside the building in which the elevator car operates). The support provider may be a building front desk or reception or in-building security. In some examples, the support provider may comprise a human support technician or engineer (e.g. located at a remote support centre) although the support provider may additionally or alternatively comprise an automated computer system. For example, the support provider may comprise an automated computer system configured to issue one or more standard queries and receive the passenger responses thereto. In some such examples a human support technician may then take over, e.g. issuing further queries and/or performing other required actions (e.g. communicating with emergency services).

The elevator control device is used primarily (i.e. during normal elevator operation) to accept elevator control commands from a passenger, to enable passenger control over operation of the elevator (e.g. to select a desired destination floor, to open or close the doors, or to operate an alarm). The inventors have recognised, however, that the same controls may be repurposed to enable the passenger to indicate their response to a query.

Because the response uses the elevator control device (i.e. a device already present in standard elevator cars), no physical modifications and/or additional hardware need to be made and/or added to a standard elevator car (e.g. the present disclosure may be realised through only software/firmware updates to an existing elevator control system).

The elevator control device may comprise any device suitable for operation by a passenger. For example, the elevator control device may comprise one or more buttons, switches or touch-sensitive regions (or a combination of one or more types of input means). In some preferred examples, the elevator control device may comprise (or be comprised by) an elevator control panel. The elevator control device may consist of a single input device (e.g. an alarm button). In some examples, the elevator car may comprise other control devices which are not used as input means for a passenger response (e.g. only the alarm button of a standard elevator control panel may be repurposed to comprise the elevator control device).

The elevator control commands that the elevator control device is arranged to accept may relate to any aspect of elevator operation, including elevator car movement, elevator car door operation, emergency stop/alarm operation or initiating an emergency call. The elevator control device may, for example, comprise a floor call button (i.e. arranged to receive a destination floor command), a door operation (i.e. open/close) button, an alarm button or an emergency stop button. In some sets of examples, the elevator control device may consist of one or more floor call buttons, one or more door operation buttons and one or more alarm/emergency stop buttons.

The elevator control device may comprise a plurality of different input devices (e.g. each assigned to a different pre-determined response to the query from the support provider). However, in some examples the elevator control device consists of a single input device (e.g. the alarm button). The elevator control device may be connected to the support provider via an elevator control or dispatch system (e.g. located outside the elevator car). However, in some examples the elevator control device is connected to the support provider via a direct connection to an external communication link (e.g. a telephone line). Such a direct connection is advantageous in emergency situations as it is less dependent on the elevator systems. Therefore, in cases where the elevator systems have failed as part of the emergency situation, the direct connection such as a telephone line may still be active and may still permit communication between the passenger and the support provider.

The elevator control device may not be operable to accept elevator control commands whilst an input provided thereto is being used to produce the response. This suspension of normal elevator control operation may, for example, be triggered when the query is communicated to the passenger.

The passenger input provided via the elevator control device on which the response is based may take different forms. The type of input may depend upon the type of query.

For example, the input provided via the elevator control device on which the response is based may comprise the passenger actuating or otherwise interacting with one of a plurality of input devices (e.g. the passenger pressing one of several buttons), with each input device representing a different response. For example, the passenger may indicate their response to the query by selecting from a plurality of buttons a button that corresponds to their desired response.

Alternatively, the input provided via the elevator control device on which the response is based may comprise the passenger actuating or otherwise interacting with only a single input device (e.g. in examples in which the elevator control device consists of only a single input device), but in a particular manner (e.g. for a specified duration or in a specified pattern). In some examples, the input provided via the elevator control device on which the response is based may comprise the passenger actuating or otherwise interacting with a single input device a particular number of times. For instance, the passenger may indicate a first response (e.g. “YES”) by actuating or otherwise interacting with the input device a first number of times and the passenger may indicate a second response (e.g. “NO”) by actuating or otherwise interacting with the input device a second number of times. In a particular example, the input provided via the elevator control device on which the response is based comprises a passenger pressing a button once to indicate a first response and the passenger pressing the button twice (e.g. in quick succession) to indicate a second response.

The response may comprise one of two options (i.e. a simple binary choice such as YES or NO). However, in some examples the response may comprise a selection from a plurality of predetermined options or even more complex responses (e.g. such as freely composed text).

The elevator car may further comprise a communication device arranged to communicate the query to the passenger by any suitable means, such as visual or audible. In some sets of examples, the communication device may comprise a screen arranged to display the query (e.g. as text and/or images/symbols) for the passenger to read or see.

In some sets of examples, the communication device may comprise a loudspeaker arranged to audibly broadcast the query (e.g. as a spoken announcement). In such examples the passenger thus hears the query to which they can then respond. In some such examples, the communication device may be arranged to broadcast live audio (e.g. a support technician speaking the query) from the support provider (e.g. transmitted over a telephone connection) via the loudspeaker.

However, the inventors have recognised that transmitting audio data (e.g. live audio from a support technician) between the support provider and the elevator car may increase bandwidth requirements. In some examples therefore, the communication device may be arranged to broadcast pre-recorded audio of the query (e.g. stored in local memory of the communication device). The communication device may comprise a speech synthesis module arranged to generate synthesised speech of the query. The communication device may be arranged to broadcast this synthesised speech via the loudspeaker. In such examples, because audio data is not transmitted between the elevator car and the support provider the bandwidth requirement of any connection between the support provider and the elevator is reduced. Furthermore, using pre-recorded or synthesised speech can reduce the workload of support staff. In addition, translation software can be used to facilitate communication where the passenger(s) and support provider personnel do not speak the same language. In such cases, translation software may be provided locally at the elevator, or remotely by the support provider (e.g. at a remote support centre) while still requiring only a low bandwidth for the actual message transmission.

The communication device may comprise other means for communicating the query. For example, the communication device may comprise a configurable indicator in conjunction with static explanatory text to communicate the query to the passenger (e.g. a set of indicator lights indicating the query from a plurality of pre-determined queries printed on a display in the elevator car).

The communication device may comprise a transmitter arranged to transmit the query to a remote device (e.g. a mobile phone or smart watch carried by the passenger, which can in turn display/announce/otherwise indicate the query to the passenger).

An audibly-communicated query may be beneficial for some passengers (e.g. those who are visually impaired), but may be unsuited to others (e.g. those who are hearing-impaired). Conversely, visual communication may also be more suited to some passengers than others. In some examples, therefore, the communication device may be arranged to communicate the query in more than one way. For example, a display may be arranged display the query (e.g. as text) and a loudspeaker may also be arranged to broadcast the query (e.g. as synthesised speech).

The query may comprise a simple question that requires a response from the passenger, for example an inquiry as to the reason an alarm button was pushed, or an inquiry into the wellbeing of the passenger(s) in the elevator car. The query may request information on the occupancy of the elevator car or information regarding the operation of the elevator car.

The query may comprise an instruction, e.g. for the passenger to perform a certain action (e.g. to help diagnose a problem with the elevator car). In such examples the response may comprise a confirmation that the instruction has been followed and/or feedback on the result of the action's performance

The query may comprise instructions on how to respond to the query (i.e. on how the elevator control device may be used to indicate the response). For example, the query may instruct the passenger to press a first button to indicate a positive response and a second different button to indicate a negative response (or alternatively to respond with a single press or double press, or similar, as discussed above).

The elevator car may be further arranged to receive and communicate one or more follow up queries, which may be at least partially based on the response to the initial query. For example, if the response to an “are you injured?” query is “YES”, one or more follow up queries may be issued to ascertain the severity of the injury. These follow up queries may also require responses which are based on further passenger input provided via the elevator control device.

### DRAWING DESCRIPTION

Certain examples of the present disclosure will now be described with reference to the accompanying drawings in which:

FIG. 1 is a block diagram of an elevator system including an elevator car according to one example of the present disclosure; and

FIG. 2 is a block diagram of an elevator system including an elevator car according to another example of the present disclosure.

### DETAILED DESCRIPTION

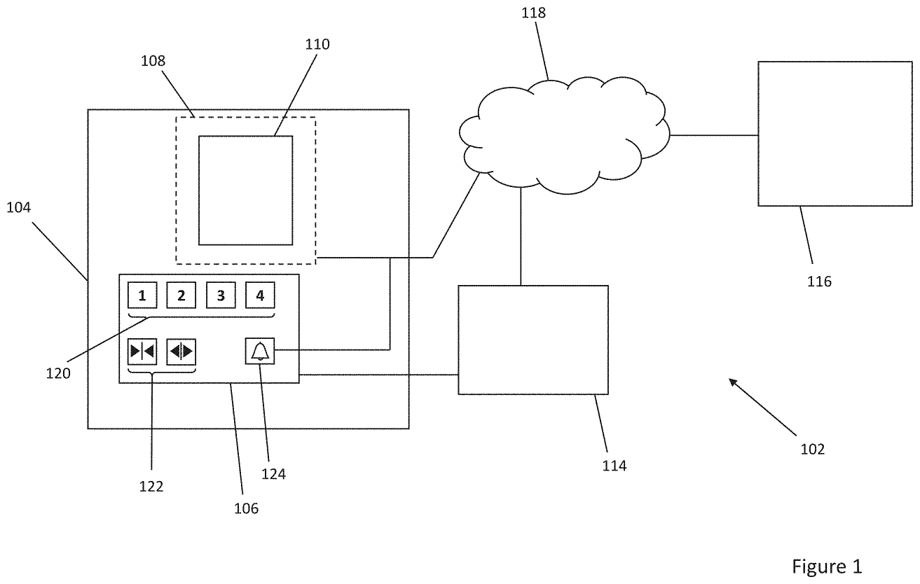

FIG. 1 shows an elevator system 102 comprising an elevator car 104 with a control panel 106 and a communication device 108 comprising a display 110. The communication device 108 is connected to a remote support centre 116 (i.e. remote from the elevator system 102) via a communication link 118 (e.g. a telephone network, a WiFi connection, a satellite connection or a communication link according to the NB-IoT or CAT-M1 protocols). The control panel 106 comprises a plurality of floor buttons 120 (corresponding to floors of a building in which the elevator car 104 operates), two door operation buttons 122 (a door open button and a door close button) and an alarm button 124. However, in other examples, different sets of buttons may be present. For example in destination control-based systems, the control panel 106 may not have floor buttons 120 and may instead only have door control and/or alarm buttons. In this example, the control panel 106 is connected to an elevator control system 114, and the alarm button 124 is also connected directly to the communication link 118, although in other examples other configurations are possible (e.g. in which all buttons are connected only to an elevator control system or to a communication link or some or all buttons are connected to both.

During normal operation of the elevator system 102, a passenger travels in the elevator car 104 between floors of a building (not shown). The passenger uses the control panel 106 to control operation of the lift (i.e. the control panel 106 acts as an elevator control device). For example, the passenger may operate a floor button 120 to select a destination floor, a door operation button 122 to open/close the elevator doors (not shown) or the alarm button 124 to signal an emergency.

During an emergency, the remote support centre 116 may communicate with the passenger (e.g. to provide information and/or guidance). As part of this communication, a support technician at the remote support centre 116 sends one or more queries to the elevator car (e.g. enquiring about the operational status of the elevator car or the wellbeing of its occupant(s)). A query from the remote support centre 116 is received by the elevator car 104 and displayed (e.g. as text) on the display 110, where it may be read by the passenger.

The query may comprise a simple YES/NO question (such as “Are you injured?”). Alternatively, the query may have a plurality of possible responses (e.g. “How many passengers are in the elevator car?”). The query may contain instructions on how a passenger can provide their response.

In an example where the query is a YES or NO question, the passenger may indicate their response to the query by pressing the alarm button 124 once to indicate a YES response and by pressing the alarm button 124 twice (in quick succession) to indicate a NO response. Of course, in other examples different numbers of presses or different patterns may be used to indicate different responses.

The response (YES or NO) based on this passenger input is then relayed to the remote support centre 116 (e.g. via the elevator control system 114 or via the direct connection from the alarm button 124 and the communication link 118).

The remote support centre 116 may subsequently send one or more further queries to the elevator car 104, which may be based on the passenger's response to the first query.

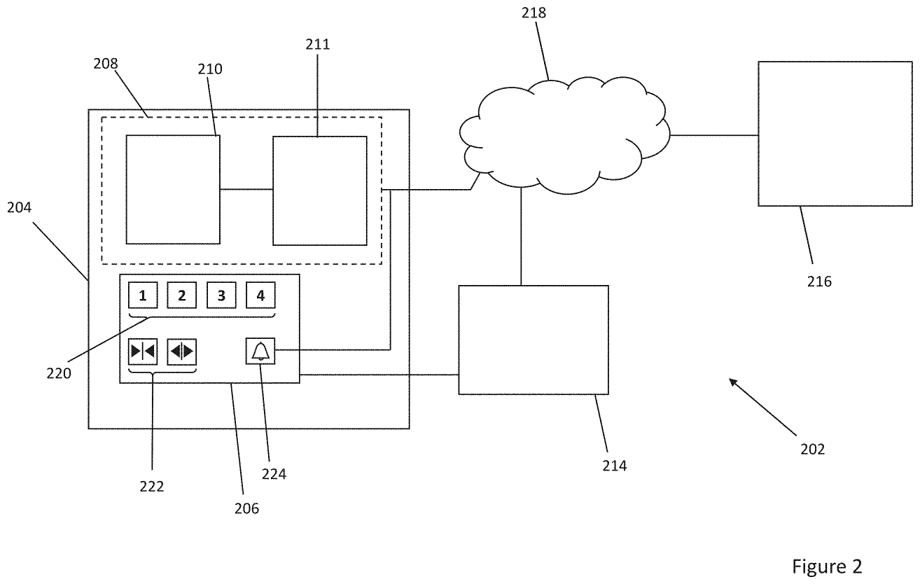

FIG. 2 shows another elevator system 202 comprising an elevator car 204 with a control panel 206 and a communication device 208. The communication device 208 is connected to a remote support centre 216 (i.e. remote from the elevator system 202) via a communication network 218. In this example, the control panel 206 comprises a plurality of floor buttons 220 (corresponding to floors of a building in which the elevator car 204 operates), two door operation buttons 222 and an alarm button 224. The control panel 206 is connected to an elevator control system 214, and the alarm button 224 is also connected directly to the communication link 218. However, in some other non-illustrated examples a control panel may comprise fewer or more buttons than the control panel 206 (e.g. an alternative control panel may not comprise floor buttons).

The communication device 208 in this exemplary elevator system 202 comprises a speech synthesis module 211 connected to a loudspeaker 210. A query from the remote support centre 216 is received by the communication device 208 (e.g. as text), where the speech synthesis module 211 synthesizes speech audio of the query. This audio is broadcast from the loudspeaker 210 such that it may be heard by the passenger. Although in this example a speech synthesis module 211 is used, in some examples direct (i.e. non-synthesised) speech (e.g. from a remote support technician) may be broadcast from the loudspeaker 210).

As with the elevator car 104 shown in FIG. 1, the passenger then indicates their response to the query by interacting with the control panel 206 (e.g. by pressing one of the buttons 220, 222, 224 corresponding to their desired response). The response is then sent over the communication link 218 to the remote support centre 216.

Features of the present disclosure are set out in the following clauses: Clause 1: An elevator car comprising an elevator control device arranged to accept an elevator control command from a passenger in the elevator car; wherein the elevator car is arranged to: receive a query from a support provider; communicate said query to the passenger; and send a response to the support provider based on passenger input provided via the elevator control device. Clause 2: The elevator car of clause 1, wherein the elevator control device comprises a floor call button, a door operation button, an alarm button or an emergency stop button. Clause 3: The elevator car of clause 1 or 2, wherein the elevator control device is connected to the support provider via a direct connection to an external communication link. Clause 4: The elevator car of clause 3, wherein the external communication system comprises a telephone line. Clause 5: The elevator car of any preceding clause, wherein the elevator control device consists of a single input device. Clause 6: The elevator car of any preceding clause, wherein the input provided via the elevator control device on which the response is based comprises the passenger actuating or otherwise interacting with a single input device a particular number of times. Clause 7: The elevator car of clause 6, wherein the input provided via the elevator control device on which the response is based comprises a passenger pressing a button once to indicate a first response and the passenger pressing the button twice to indicate a second response. Clause 8: The elevator car of any preceding clause, further comprising a communication device arranged to communicate the query to the passenger. Clause 9: The elevator car of clause 8, wherein the communication device comprises a screen arranged to visibly display the query. Clause 10: The elevator car of clause 8 or 9, wherein the communication device comprises a loudspeaker arranged to audibly broadcast the query. Clause 11: The elevator car of clause 8, wherein the communication device further comprises a speech synthesis module arranged to generate synthesised speech of the query, and the communication device is arranged to broadcast this synthesised speech via the loudspeaker. Clause 12: The elevator car of any preceding clause, wherein the query comprises instructions on how to respond to the query. Clause 13: A method of communication between a passenger in an elevator car and a support provider, said car comprising an elevator control device arranged to accept an elevator control command from the passenger, said method comprising: the elevator car receiving a query from the support provider; communicating said query to the passenger; and sending a response to the support provider based on passenger input provided via the elevator control device. Clause 14: The method of clause 13, wherein the query and response are transmitted via a telephone line. Clause 15: The method of clause 13 or 14, wherein the response is generated from a single input device of the elevator control device.

What is claimed is:

1. An elevator car comprising an elevator control device arranged to accept an elevator control command from a passenger in the elevator car; wherein the elevator car is arranged to:
receive a query from a support provider;
communicate said query to the passenger; and
send a response to the support provider based on passenger input provided via the elevator control device.

2. The elevator car as claimed in claim 1, wherein the elevator control device comprises a floor call button, a door operation button, an alarm button or an emergency stop button.

3. The elevator car as claimed in claim 1, wherein the elevator control device is connected to the support provider via a direct connection to an external communication link.

4. The elevator car as claimed in claim 3, wherein the external communication system comprises a telephone line.

5. The elevator car as claimed in claim 1, wherein the elevator control device consists of a single input device.

6. The elevator car as claimed in claim 1, wherein the input provided via the elevator control device on which the response is based comprises the passenger actuating or otherwise interacting with a single input device a particular number of times.

7. The elevator car as claimed in claim 6, wherein the input provided via the elevator control device on which the response is based comprises a passenger pressing a button once to indicate a first response and the passenger pressing the button twice to indicate a second response.

8. The elevator car as claimed in claim 1, further comprising a communication device arranged to communicate the query to the passenger.

9. The elevator car as claimed in claim 8, wherein the communication device comprises a screen arranged to visibly display the query.

10. The elevator car as claimed in claim 8, wherein the communication device comprises a loudspeaker arranged to audibly broadcast the query.

11. The elevator car as claimed in claim 8, wherein the communication device further comprises a speech synthesis module arranged to generate synthesised speech of the query, and the communication device is arranged to broadcast this synthesised speech via the loudspeaker.

12. The elevator car as claimed in claim 1, wherein the query comprises instructions on how to respond to the query.

13. A method of communication between a passenger in an elevator car and a support provider, said car comprising an elevator control device arranged to accept an elevator control command from the passenger, said method comprising:
the elevator car receiving a query from the support provider;
communicating said query to the passenger; and
sending a response to the support provider based on passenger input provided via the elevator control device.

14. The method of claim 13, wherein the query and response are transmitted via a telephone line.

15. The method of claim 13, wherein the response is generated from a single input device of the elevator control device.
